(19) United States
(12) Patent Application Publication
(10) Pub. No.: US 2026/0359199 A1
(43) Pub. Date: Nov. 12, 2026

(54) Fuzzing using AI-Generated Mutators

(71) Applicant: Mellanox Technologies, Ltd., Yokneam (IL)

(72) Inventors: Daniel Bransky, Nesher (IL); Alon Ashkenazi, Rosh Haayin (IL); Matar Haller, Hogla (IL); Eliya Cohen, Kfar Mimon (IL)

(21) Appl. No.: 19/562,939

(22) Filed: Mar. 11, 2026

Related U.S. Application Data
(60) Provisional application No. 63/801,890, filed on May 8, 2025.

(51) Int. Cl. G06F 11/3668

(52) U.S. Cl. CPC G06F 11/3676; G06F 11/3684

(57) ABSTRACT

A method for software testing includes receiving a set of test inputs for testing target software code. An iterative process is performed. The iterative process improves a quality measure of testing the target software code by the test inputs. A given iteration of the iterative process includes applying one or more Artificial Intelligence (AI) models to the test inputs so as to: (i) generate one or more mutators, each mutator including executable code that produces one or more suggested mutations to the set of test inputs, and (ii) test the target software code using the suggested mutations so as to identify one or more selected mutations that improve the quality measure, and adding the selected mutations to the set of test inputs.

### CROSS-REFERENCE TO RELATED APPLICATIONS

This application claims the benefit of U.S. Provisional Patent Application 63/801,890, filed May 8, 2025, whose disclosure is incorporated herein by reference.

### TECHNICAL FIELD

The present disclosure relates generally to software testing, and more particularly but not exclusively to automated fuzzing techniques that utilize artificial intelligence to generate test inputs for improving code coverage.

### BACKGROUND

Software testing encompasses various techniques for evaluating the behavior and reliability of computer programs. Among these techniques, fuzzing has emerged as an automated approach that involves providing diverse inputs to software code with the goal of discovering bugs, vulnerabilities, and unexpected behaviors. Fuzzing systems typically aim to maximize code coverage, which refers to the extent to which the test inputs exercise different portions of the target software code during execution.

Conventional fuzzing approaches employ genetic algorithms that mutate inputs, test them against target code, and preserve inputs that trigger new coverage for further mutation. These approaches utilize generic mutators, such as bit-flip operations, havoc mutations, and splice operations, to transform inputs. However, such generic mutators operate without awareness of the underlying code structure, which can result in mutations that fail to explore certain code paths.

### SUMMARY

An embodiment that is described herein provides a method for software testing. The method includes receiving a set of test inputs for testing target software code. An iterative process is performed. The iterative process improves a quality measure of testing the target software code by the test inputs. A given iteration of the iterative process includes applying one or more Artificial Intelligence (AI) models to the test inputs so as to: (i) generate one or more mutators, each mutator including executable code that produces one or more suggested mutations to the set of test inputs, and (ii) test the target software code using the suggested mutations so as to identify one or more selected mutations that improve the quality measure, and adding the selected mutations to the set of test inputs.

In some embodiments, the iterative process improves the quality measure by increasing a coverage of the target software code by the test inputs. Additionally or alternatively, the iterative process improves the quality measure by triggering one or more bugs in the target software code.

In some embodiments, generating the one or more mutators includes (i) identifying a portion of the target software code that is not reached by the set of test inputs, and (ii) generating at least one mutator that produces at least one suggested mutation expected to reach the identified portion.

In some embodiments, generating the one or more mutators includes selecting, from the target software code, a software function to be researched next, and generating a mutator that produces a suggested mutation expected to improve the coverage of the selected software function. In an example embodiment, selecting the software function includes applying a selection criterion that considers, for a candidate function, a current coverage of the candidate function. Additionally or alternatively, selecting the software function includes applying a selection criterion that considers a threat model defined for the target software code. Further additionally or alternatively, selecting the software function includes applying a selection criterion that considers, for a candidate function, a location of the candidate function relative to an entry point to a flow tree model representing the target software code.

In a disclosed embodiment, the method further includes coalescing two or more of the mutators. In a disclosed embodiment, the method further includes discarding a mutator that produces a suggested mutation that is similar to a previous suggested mutation, in accordance with a defined similarity criterion.

In some embodiments, generating the one or more mutators includes providing the one or more AI models with a state of the target software code from an active software debugger. In an example embodiment, the state of the target software code, provided from the active software debugger to the one or more AI models, pertains to a line of the target software code that blocks the set of test inputs from reaching a portion of the target software code. In an example embodiment, the method further includes enabling the one or more AI models to execute the target software code incrementally so as to modify the state, and to access the modified state of the target software code.

There is additionally provided, in accordance with an embodiment that is described herein, a system for software testing. The system includes a memory and one or more processors. The memory is to store target software code. The one or more processors are to receive a set of test inputs for testing the target software code, and to perform an iterative process that improves a quality measure of testing the target software code by the test inputs. A given iteration of the iterative process includes applying one or more Artificial Intelligence (AI) models to the test inputs to: (i) generate one or more mutators, each mutator including executable code that produces one or more suggested mutations to the set of test inputs, and (ii) test the target software code using the suggested mutations so as to identify one or more selected mutations that improve the quality measure, and adding the selected mutations to the set of test inputs.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a software testing system, in accordance with an embodiment that is described herein; and

FIG. 2 is a flow chart that schematically illustrates a method for software testing, in accordance with an embodiment that is described herein.

### DETAILED DESCRIPTION OF EMBODIMENTS

### Overview

Conventional fuzzing techniques face significant limitations in achieving comprehensive code testing, e.g., a high level of coverage. Known generic mutators operate without awareness of the underlying code structure, resulting in suboptimal mutations that fail to explore all relevant code paths. While manual approaches exist, these approaches require considerable manual effort and specialized expertise. Automated methods such as compiler-based dictionary generation during compilation provide some improvement but remain limited in their ability to intelligently navigate complex code structures. Such approaches are inherently static, in the sense that the mutators and dictionaries do not adapt according to the testing results.

Embodiments that are described herein provide improved techniques for automated software testing, which combine coverage-guided fuzzing with artificial intelligence reasoning to systematically identify and overcome limitations in test quality. The disclosed techniques can be used, for example, to improve coverage of target software code and/or to improve bug discovery and triggering. The disclosed techniques employ a research-driven methodology where coverage blockages or bugs are identified, hypotheses are formulated to overcome them, experiments are synthesized to test the hypotheses, and results are validated.

In some embodiments, a disclosed software testing system operates on target software code using an initial corpus of test inputs and progressively expands coverage through an intelligent, iterative refinement process. The system leverages one or more Artificial Intelligence (AI) models that analyze the relationship between existing test inputs and the target code structure to synthesize new test input variations ("mutations") designed to exercise previously untested code paths.

As the AI models generate the suggested mutations, the system evaluates their effectiveness by applying them to the target software code and monitoring which mutations successfully trigger execution of new code regions. Mutations demonstrating coverage improvements are incorporated into the growing corpus of test inputs, enriching the set for subsequent iterations.

In some embodiments, the system has the capability of pinpointing blockages, i.e., portions of the target software code that remain unreached by the current test input corpus. For a given identified blockage, the AI models craft targeted mutations specifically designed to penetrate these unexplored regions.

In some embodiments, the AI models synthesize executable mutator code ("mutators") rather than directly producing individual mutations. Each mutator comprises a self-contained executable program capable of generating adapted test inputs ("mutations") according to learned patterns and code-aware strategies. The system executes the mutators to generate the suggested mutations. The mutator generation process involves the AI models analyzing unreached portions of the target software code and constructing mutators specifically tailored to produce input variations likely to penetrate those regions.

In some embodiments, the system selects individual software functions within the target code for focused investigation and generates mutators optimized to improve coverage within each selected function. Function selection is typically guided by criteria that weigh factors like the current coverage state of candidate functions, threat model considerations that prioritize security-sensitive code regions, and the location of the function relative to the entry point to the code flow tree.

In some embodiments, the system enhances its mutation evaluation efficiency by coalescing operations that merge complementary mutators, and deduplication mechanisms that eliminate mutators producing outputs too similar to previously generated mutations. In some embodiments, at least some of the generated mutators target the reproduction of discovered bugs within the target software code.

By leveraging AI models to analyze code structure, coverage data, and input characteristics, the disclosed system produces targeted mutations that are more likely to explore previously unreached code paths. The iterative feedback loop between hypothesis generation, experiment synthesis, and validation, enables continuous refinement of mutation strategies until coverage blockages are overcome, resulting in improved code coverage and more effective discovery of bugs and vulnerabilities in target software.

### Definitions

In the present context, the term "mutation" refers to an adapted or transformed version of a test input, aiming to improve target software code. A mutation may be generated by modifying byte values, altering the structure, or otherwise transforming an original test input to reach previously untested code regions. For example, a mutation may involve changing specific byte sequences in an input buffer to satisfy a conditional check that guards an unexplored code branch.

In the present context, the term "mutator" refers to executable code that generates one or more mutations. A mutator may generate a mutation, for example, according to learned patterns and code-aware strategies. A mutator may comprise a self-contained program capable of producing adapted test inputs and may be loaded into a fuzzer for automated execution. For example, a mutator may be a Python function that takes an input buffer and produces a modified version targeting specific code conditions.

In the present context, the term "blockage" refers to a portion of target software code that remains unreached during testing. A blockage may represent a code region, e.g., one or more lines of code, that no test input in the current corpus is able to exercise, often due to conditional checks or constraints that the existing inputs fail to satisfy. For example, a blockage may be caused by a code branch guarded by a conditional check that compares an input value against a specific constant, where no test input in the current corpus provides a value that satisfies the condition.

In the present context, the term "fuzzer" refers to a software tool or program that provides diverse inputs to target software code with the goal of discovering bugs, vulnerabilities, or unexpected behaviors. A fuzzer may monitor the target software for crashes or other anomalous behavior, as well as coverage changes.

### System Description

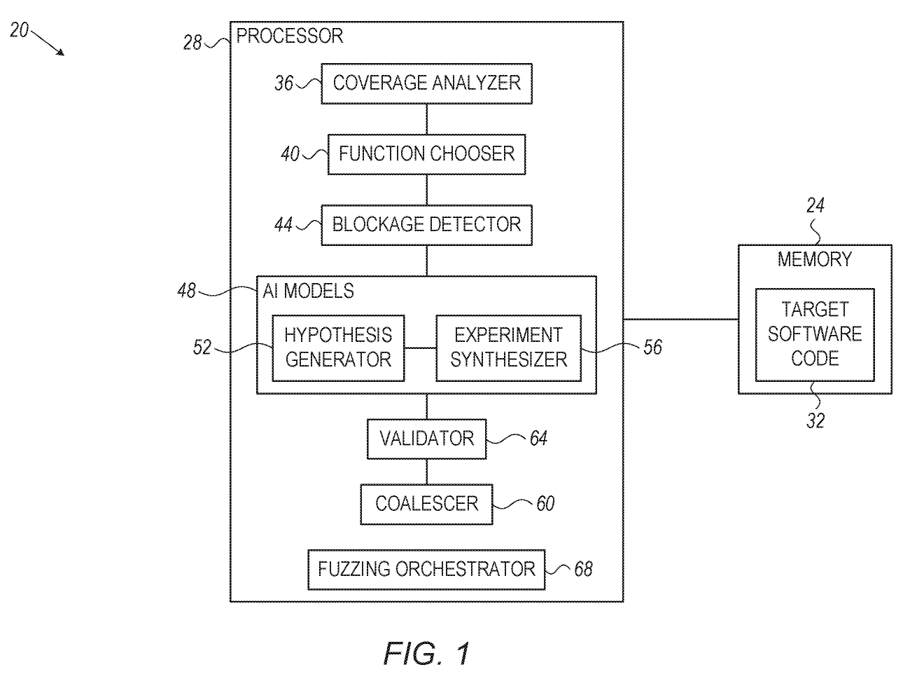

FIG. 1 is a block diagram that schematically illustrates a software testing system 20, in accordance with an embodiment that is described herein. System 20 comprises a memory 24 and a processor 28. Memory 24 stores target software code 32, which represents the software to be tested by the system. Processor 28 comprises multiple components that work together to perform the disclosed software testing techniques.

The description that follows refers mainly to iterative improvement of test coverage. The disclosed techniques, however, can be used in a similar manner to produce mutations that improve other test quality measures, e.g., to improve triggering of bugs in the target software code.

In the example of FIG. 1, processor 28 comprises a coverage analyzer 36 configured to produce coverage reports indicating which portions of target software code 32 have been executed during testing. In various embodiments, coverage analyzer 36 may produce the coverage data with various degrees of granularity. In an example embodiment, the coverage data has a granularity of individual code lines, e.g., an indication per line stating whether the respective line of software code 32 is reached by the current set of test inputs. Generally, however, any other suitable granularity can be used. The granularity need not be uniform across code 32.

A function chooser 40 is coupled to coverage analyzer 36 and is configured to select functions within target software code 32 for further analysis. In various embodiments, function chooser 40 may select functions for analysis based on various selection criteria. In a typical embodiment, the selection criterion considers, for a candidate function, (i) the current coverage of the candidate function and (ii) a threat model defined for the target software code. The threat model may indicate, for example, regions of code 32 that are particularly security-sensitive or particularly vulnerable to attacks. A blockage detector 44 is coupled to function chooser 40 and is configured to identify code blockages.

Processor 28 further comprises one or more AI models 48 that are configured to generate mutators and mutations. Any of AI models 48 may comprise either a generic large language model or a fine-tuned model specifically trained to generate fuzzing mutators. In the present example, AI models 48 comprise a hypothesis generator 52 and an experiment synthesizer 56. Hypothesis generator 52 is configured to formulate testable hypotheses for bypassing identified code blockages. Experiment synthesizer 56 is coupled to hypothesis generator 52 and is configured to generate mutators (executable code that produces mutations) based on the hypotheses produced by hypothesis generator 52. In alternative embodiments, any other suitable number and types of AI models can be used.

A validator 64 is configured to validate the generated mutators and confirm or refute hypotheses based on experiment results. A coalescer 60 is configured to combine multiple experiments into fuzzing mutators that can be loaded into a fuzzer.

A fuzzing orchestrator 68 is configured to manage the execution of fuzzers with custom mutators, coordinating the overall fuzzing campaign against target software code 32.

The configurations of system 20 and its components, e.g., processor 28, as illustrated in FIG. 1, are example configurations that are chosen purely for the sake of conceptual clarity. In alternative embodiments, any other suitable configuration can be used. For example, the functions of processor 28 may be split among multiple processors. Any other partitioning or architecture can be used for the software modules running in processor 28.

In various embodiments, system 20 may be implemented using suitable hardware, such as in one or more Application-Specific Integrated Circuits (ASICs) or Field-Programmable Gate Arrays (FPGAs), using software, or using a combination of hardware and software elements. Elements that are not mandatory for understanding of the disclosed techniques have been omitted from the figure for the sake of clarity.

Typically, processor 28 comprises a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Coverage Enhancement Using AI-Generated Code-Aware Mutators

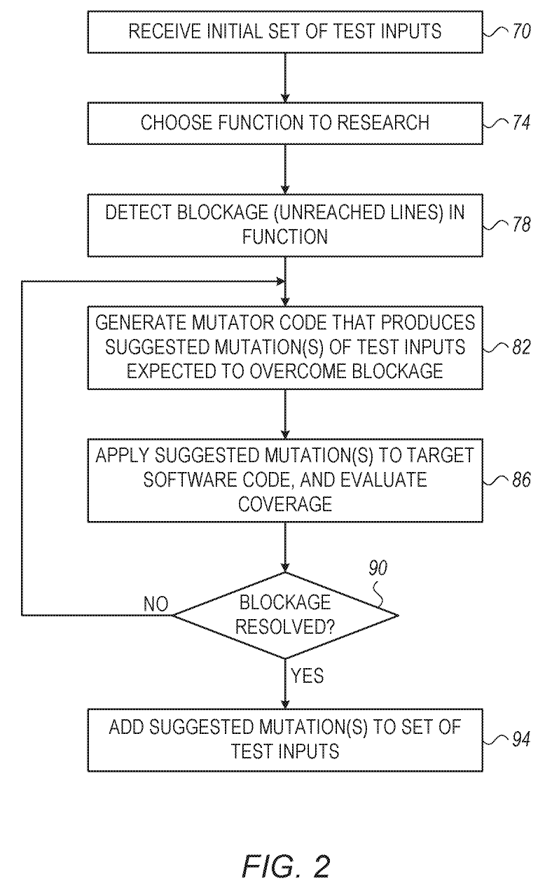

FIG. 2 is a flow chart that schematically illustrates a method for software testing, in accordance with an embodiment that is described herein. The method is carried out by the various software components running in processor 28 of system 20, orchestrated by fuzzing orchestrator 68. FIG. 2 depicts the analysis and testing of a single function in target software code 32, for the sake of clarity. In a typical embodiment, the flow of FIG. 2 is repeated, selecting additional functions for testing.

The method begins at an initial input stage 70, in which system 20 receives an initial set of test inputs for testing target software code 32. The initial set of test inputs may comprise, for example, seed inputs that exercise basic functionality of the target software code.

At a function choosing stage 74, function chooser 40 in processor 28 selects a function within target software code 32 to research. As described above, the selection may be based on criteria that consider the current coverage state of candidate functions and threat model considerations that prioritize security-sensitive code regions.

At a blockage detection stage 78, blockage detector 44 in processor 28 detects blockages in the form of unreached lines within the chosen function. The blockage detection may involve analyzing coverage data produced by coverage analyzer 36 to identify portions of the selected function that have not been executed by any test input in the current corpus.

At a mutator generation stage 82, AI models 48 in processor 28 generate mutator code that produces suggested mutations of test inputs expected to overcome the detected blockage. In particular, hypothesis generator 52 formulates hypotheses regarding how to reach the unreached code portions, and experiment synthesizer 56 generates executable mutators based on these hypotheses.

At a mutation evaluation stage 86, validator 64 in processor 28 applies the suggested mutations produced by the generated mutators to target software code 32. In some embodiments, prior to applying the mutators, coalescer 60 in processor 28 coalesces groups of mutators together, so as to produce coalesced mutators. The coalesced mutators are provided to validator 64 for execution. Coverage analyzer 36 in processor 28 evaluates the resulting coverage. The evaluation determines whether the suggested mutations successfully trigger execution of previously unreached code regions.

At a blockage re-checking stage 90, blockage detector 44 checks whether the blockage has been resolved. If the blockage is not resolved (No branch), the method returns to mutator generation stage 82, where AI models 48 generate new mutator code based on the evaluation results from the previous iteration. This iterative loop enables continuous refinement of mutation strategies until the blockage is overcome.

If the blockage is resolved (Yes branch), the method proceeds to a test input updating stage 96, in which orchestrator 68 adds the suggested mutations that successfully increased coverage to the set of test inputs. The enriched set of test inputs may then be used in subsequent iterations to further expand coverage of target software code 32.

### Processor Components

This section provides additional details of the multiple components of processor 28, in accordance with a non-limiting example embodiment. In alternative embodiments, any other suitable structure and/or functionality can be used.

### Coverage analyzer

In some embodiments, coverage analyzer 36 provides structured representation of program execution coverage. Coverage analyzer 36 receives target software code 32, a coverage-instrumented target binary, and a collection of test inputs. Coverage analyzer 36 executes each given input against the coverage-instrumented executable and produces coverage reports indicating which portions of target software code 32 have been executed during testing.

In an example embodiment, coverage analyzer 36 produces two types of coverage data. First, coverage analyzer 36 generates a system-wide per-function coverage report that indicates coverage percentages for each function in target software code 32. Second, coverage analyzer 36 produces line-by-line coverage annotations for selected functions, where each line is formatted with a line number, a coverage status indicating whether the line was executed (1) or not executed (0), and the code content. The coverage data is queryable at a function level or a line-by-line level, meaning that other components can check for coverage by lines, functions, or files.

### Function chooser

In some embodiments, function chooser 40 is coupled to coverage analyzer 36 and selects functions within target software code 32 for further analysis. Function chooser 40 receives (i) the queryable coverage analysis object from coverage analyzer 36 and (ii) a project-level threat model.

Function chooser 40 applies selection criteria that consider multiple factors. First, function chooser 40 evaluates the current coverage of candidate functions, where a function with coverage higher than zero percent and lower than one hundred percent is a candidate because such a function has potential to improve coverage. Second, function chooser 40 considers a threat model defined for target software code 32, which indicates regions of code that are particularly security-sensitive or vulnerable to attacks. Function chooser 40 outputs one or more functions with blockages, where the current corpus does not cover a portion of the selected function.

### Blockage detector

In some embodiments, blockage detector 44 is coupled to function chooser 40 and identifies code blockages that remain unreached during testing. Blockage detector 44 receives coverage-annotated source code from coverage analyzer 36, where each line includes a coverage status.

Blockage detector 44 performs several processing operations. First, blockage detector 44 extracts uncovered lines by parsing the coverage-annotated source code and filtering to identify executable lines with zero coverage, excluding non-executable elements such as comments, preprocessor directives, blank lines, and standalone braces. Second, blockage detector 44 identifies target lines by extracting the line number, code content, and full raw line representation for each uncovered executable line. Third, blockage detector 44 discovers gating conditions by analyzing the code to identify all control flow predicates that lexically dominate the target line within the same function or scope. Blockage detector 44 identifies blocking constructs across multiple categories comprising conditionals (if statements, else-if branches, switch-case statements), loops (for loops, while loops, do-while constructs), and exception handling (try blocks, catch/except handlers, finally blocks).

Fourth, blockage detector 44 extracts and analyzes constraints for each identified blocking predicate, analyzing variable references, comparison operators, and logical relationships. Fifth, blockage detector 44 performs reachability reasoning by synthesizing how all blocking conditions must be satisfied for the target line to execute, generating one or more passing options that specify variable values or relationships that would satisfy each constraint.

Blockage detector 44 leverages a Large Language Model (LLM) for semantic code understanding and control flow analysis. This approach is language-agnostic and works across multiple programming languages without syntax-specific parsers. Blockage detector 44 outputs a blockage data structure for each uncovered line, containing target line information, blocking conditions, constraint satisfaction requirements, and a reachability explanation.

### Hypothesis generator

In some embodiments, hypothesis generator 52 formulates testable hypotheses for bypassing identified code blockages. Hypothesis generator 52 receives the blockage data from blockage detector 44, a corpus of existing inputs that produced current coverage, source code context with static query capabilities, a target under debug frozen at the blockage, and results from previous experiments.

Hypothesis generator 52 may be equipped with code analysis tools comprising both static and dynamic tools. A static code indexer enables hypothesis generator 52 to search and query the entire code base. A dynamic debugger tool enables hypothesis generator 52 to start the target in debug mode with any one of the inputs that reach the blocker and freeze on the blocker, allowing hypothesis generator 52 to query dynamic data about the blocker.

Hypothesis generator 52 produces brute force hypotheses that test many different options to bypass the blocker rather than producing just a single new input. For example, a hypothesis produced by hypothesis generator 52 states that if the first five bytes are tested against decimal values one through one hundred, then the blockage is bypassed.

### Experiment synthesizer

In some embodiments, experiment synthesizer 56 is coupled to hypothesis generator 52 and generates executable mutation code that implements hypothesis-driven input generation strategies. Experiment synthesizer 56 validates generated code through a multi-stage pipeline with error-aware retry logic to ensure syntactic correctness, safety, and functional validity.

Experiment synthesizer 56 employs state graph-based orchestration with a sequential validation pipeline and adaptive regeneration. The validation pipeline comprises multiple validators executed in sequence. A syntax validator attempts to parse code into an Abstract Syntax Tree and verifies bytecode generation capability. A function signature validator verifies that a function with the required name and exact parameter signature exists. An import validator enforces library usage policies by checking imports against an allowed list and detecting forbidden imports. A runtime validator verifies that code executes successfully across diverse input scenarios without crashes, timeouts, or type errors.

The runtime validator generates test cases across five categories: random binary data, empty and short inputs as edge cases, special byte patterns comprising boundary values, sequential patterns with ordered byte sequences, and mixed content with larger random inputs. The runtime validator also performs security pre-validation by scanning for dangerous code patterns comprising file operations, network operations, process control, code injection, introspection, and system access.

Experiment synthesizer 56 implements error-aware regeneration that maps validation failures to specialized retry prompts based on error type classification. The retry mechanism incorporates the original hypothesis for continuity, error type classification, detailed error diagnostics comprising line numbers, messages, and stack traces, the failed code for comparison, and remediation guidance with validator-specific suggestions. Experiment synthesizer 56 supports configurable retry limits with a default of three attempts before terminal failure.

### Coalescer

In some embodiments, coalescer 60 is coupled to experiment synthesizer 56 and combines multiple experiments into fuzzing mutators that can be loaded into a fuzzer. Coalescer 60 receives experiments that implement hypotheses and functions that test inputs against a fuzzing corpus (a set of test inputs).

Coalescer 60 generates a mutator that manages multi-function dispatch by determining how many functions of all the functions are still producing new inputs and sending the same input from the fuzzer to all of them. The generated mutator has an internal feedback loop that for each function exports a log file and logs new inputs. When a function stops discovering new branches, coalescer 60 removes that function from the running functions. When all functions are exhausted, the mutator is stopped. Coalescer 60 outputs a fuzzer-ready mutator.

### Validator

In some embodiments, validator 64 is coupled to coalescer 60 and validates the generated mutators by confirming or refuting hypotheses based on experiment results. Validator 64 receives the new test cases generated by the experiment and the blockage under research.

Validator 64 uses coverage analyzer 36 to test whether the blockage was solved. If the blockage is resolved, validator 64 marks the research as resolved. If the blockage remains unresolved, validator 64 passes the results back to hypothesis generator 52 to generate a new hypothesis based on the empirical experiment results.

### Fuzzing orchestrator

In some embodiments, fuzzing orchestrator 68 is coupled to validator 64 and manages the execution of fuzzers with custom mutators, coordinating the overall fuzzing campaign against target software code 32. Fuzzing orchestrator 68 receives mutators from coalescer 60.

Fuzzing orchestrator 68 manages a queue of mutators and manages the running fuzzers for a given number of processor cores. Fuzzing orchestrator 68 outputs a corpus of inputs for each fuzzer, which enriches the set of test inputs for subsequent iterations.

### Additional Embodiments and Variations

This section describes additional embodiments and variations of the disclosed software testing techniques, in accordance with example embodiments.

### Integration with active debugger

In some embodiments, processor 28 runs, or interfaces with, a software debugging tool (referred to herein as "active debugger") that is configured to debug target software code 32. Processor 28 enables hypothesis generator 52 to access and operate the active debugger in order to produce better hypotheses. One example debugger that can be used for this purpose is the Gnu debugger ("GDB"), although any other suitable debugging tool can be used.

In a typical embodiment, processor 28 provides hypothesis generator 52 with (i) a line of target software code 32 identified as a blockage, (ii) one or more test inputs that reach the blockage line, and (iii) a state ("snapshot") of the active debugger, frozen on the blockage line. The frozen snapshot provided by the debugger comprises the complete state of the target software code when the blockage line is reached, including memory contents, variable values, etc. Hypothesis generator 52 may use this information to produce better-quality hypotheses.

In some embodiments, hypotheses generator 52 can also use the active debugger to execute the target software code incrementally, e.g., line-by-line, starting from the blockage line. Hypothesis generator 52 may run the target software code forward or backwards, so as to modify the state of the target software code, and access the resulting state information. This capability provides the hypothesis generator with richer information, enabling it to generate better hypotheses.

The description above refers to the use of an active debugger for generating improved hypotheses for overcoming blockages (and thus improving coverage). Additionally or alternatively, hypotheses generator 52 also use the active debugger to improve other types of hypotheses, e.g., hypotheses aiming to identify bugs or security vulnerabilities in the target software code.

### Initial fuzzer phase and user-configurable fuzzer count

In some embodiments, fuzzing orchestrator 68 starts a user-configurable number N of conventional ("vanilla") fuzzers against the target executable provided by the user. These fuzzers continue fuzzing in the background while the system generates custom mutators. The vanilla fuzzers use conventional generic mutators such as bit-flip, havoc, and splice operations. As custom mutators become available, fuzzing orchestrator 68 progressively replaces vanilla fuzzers with fuzzers loaded with the custom mutators.

### Time-based fuzzing intervals

In some embodiments, system 20 fuzzes the target software code for a configurable time period T with the goal of discovering unique inputs that are placed by each fuzzer into the corpus. After time period T elapses, coverage analyzer 36 receives a set of B inputs chosen from the corpus, where the inputs are chosen randomly or according to selection criteria. Coverage analyzer 36 produces a system-wide per-function coverage report using a precompiled target that supports producing coverage reports. The system then proceeds to function selection and mutator generation stages before returning to another fuzzing interval.

### LLM-based function selection

In some embodiments, function chooser 40 prompts AI models 48 to select functions for analysis. In an example embodiment, function chooser 40 provides AI models 48 with the entire coverage report, the inputs that produced the coverage, and the location of each function in a code flow tree or the entire code flow tree. AI models 48 analyze this information and select functions that have the highest potential for coverage improvement or vulnerability discovery.

### Mathematical model for function selection

In alternative embodiments, function chooser 40 uses a predefined mathematical model to select functions for analysis. The mathematical model considers coverage parameters and the potential for improvement. Functions with coverage of zero percent or one hundred percent are excluded from selection, as functions with zero percent coverage have not been reached by any test input and functions with one hundred percent coverage have no room for improvement.

### Code flow tree analysis

In some embodiments, system 20 analyzes a code flow tree that represents the calling relationships between functions in target software code 32. The code flow tree indicates which functions call which other functions and the hierarchical structure of the code. Function chooser 40 uses the code flow tree to prioritize functions that are reachable from entry points and that gate access to large portions of uncovered code.

### Fine-tuned model for predicting mutator efficiency

In some embodiments, validator 64 uses a fine-tuned model to predict the efficiency or potential of generated mutators before deploying them to fuzzers. The fine-tuned model is trained on historical data comprising mutator code and corresponding coverage improvements achieved by each mutator. Validator 64 provides the generated mutator code to the fine-tuned model, which outputs a predicted efficiency score. Mutators with predicted efficiency scores below a threshold are rejected and returned to experiment synthesizer 56 for regeneration.

### Mutator uniqueness and similarity checking

In some embodiments, validator 64 performs similarity checks to determine whether generated mutators are unique enough compared to previously generated mutators. Validator 64 maintains a history of previously generated mutators and compares each new mutator against this history. Mutators that exceed a similarity threshold compared to previous mutators are rejected to ensure diversity in the mutator pool.

### Runtime metrics for fuzzer evaluation

In some embodiments, fuzzing orchestrator 68 evaluates runtime metrics from each running fuzzer to determine the fuzzer performance. The runtime metrics may comprise, for example, time since last discovery, which indicates how long since the fuzzer found a new unique input; total run time of the fuzzer; pending inputs that have not yet been fuzzed; total discoveries made by the fuzzer; and crashes found by the fuzzer. Fuzzing orchestrator 68 collects these metrics from each fuzzer and uses them to identify underperforming fuzzers.

### Weakest fuzzer replacement strategy

When new custom mutators become available, fuzzing orchestrator 68 identifies the weakest fuzzers (fuzzers that run weakest mutations) based on the runtime metrics and stops them to make room for new fuzzers loaded with the custom mutators. Fuzzing orchestrator 68 ranks running fuzzers according to a scoring function that weights the runtime metrics. Fuzzers with low scores, indicating poor performance such as long time since last discovery or few total discoveries, are classified as weak fuzzers. Fuzzing orchestrator 68 stops the F weakest fuzzers and starts F new fuzzers, each loaded with one of the newly generated custom mutators.

### Chain of prompts for mutator generation

Experiment synthesizer 56 uses a chain of prompts against AI models 48 to generate valid mutators. The chain of prompts comprises multiple sequential prompts that progressively refine the generated mutator. A first prompt provides the hypothesis, coverage data, and function context to generate an initial mutator. Subsequent prompts provide validation feedback, error messages, and remediation guidance to correct issues in the generated mutator. This chain of prompts approach increases the likelihood of generating a valid mutator that passes all validation stages.

### Parallel blockage processing

In some embodiments, blockage detector 44 analyzes multiple uncovered lines concurrently when multiple uncovered lines exist within target software code 32. Blockage detector 44 supports both thread-based and process-based parallelization for concurrent analysis. Blockage detector 44 comprises progress tracking capabilities for large-scale analysis of target software code 32 with numerous uncovered lines.

### Language-agnostic analysis

In some embodiments, the blockage detection approach employed by blockage detector 44 is language-agnostic and works across multiple programming languages comprising C, C++, Python, and other languages without requiring syntax-specific parsers. This language-agnostic approach leverages the semantic understanding capabilities of AI models 48 to handle implicit control flow and complex Boolean logic across different programming language syntaxes.

### Target language support for mutators

Experiment synthesizer 56 may support generating mutators in multiple target language, e.g., Python and C. The target language is configurable, allowing the system to generate mutators appropriate for the fuzzing infrastructure in use. For Python targets, experiment synthesizer 56 may use a Python interpreter for validation. For C targets, experiment synthesizer 56 can invoke a C compiler such as GCC for syntax validation.

### Structured JSON output format

In some embodiments, blockage detector 44 outputs blockage data in a structured JSON format that is machine-parseable for downstream processing by other components of system 20. The structured JSON format may comprise, for example, target line information, blocking conditions, constraint satisfaction requirements, and reachability explanations. This structured format enables automated processing by hypothesis generator 52 and other components.

### Reachability explanation output

In some embodiments, blockage detector 44 generates natural language descriptions of what must be true or false at each blocking condition to reach a certain target line. The reachability explanation provides guidance on how to reach the target line when determinable and context about why the line remained uncovered, such as upstream control flow constraints or the function never being invoked.

### Configurable timeout per stage

In some embodiments, system 20 supports configurable time limits for generation and validation stages within experiment synthesizer 56. In an example configuration, the default timeout for generation is thirty seconds and the default timeout for validation is ten seconds per test. These timeout values are configurable to accommodate different target software code complexity levels and computational resources.

### Memory limits for code execution

In some embodiments, the runtime validator within experiment synthesizer 56 enforces configurable memory limits for code execution during validation. In an example configuration, the default memory limit is one hundred megabytes. The memory limit prevents generated mutators from consuming excessive system resources during validation and ensures that mutators operate within acceptable resource constraints when deployed to fuzzers.

### Allowed and forbidden import configuration

In some embodiments, the import validator within experiment synthesizer 56 supports configurable allowed and forbidden library lists. The allowed list specifies libraries that generated mutators are permitted to import, such as random, struct, typing, and itertools for Python mutators. The forbidden list specifies libraries that are prohibited, such as os, subprocess, sys, and other libraries that could enable dangerous operations. This configuration enables customization of security policies for generated mutator code based on the deployment environment.

In various embodiments the methods and systems described herein can be used for testing any suitable type of system involving software, e.g., operating systems, embedded firmware and the like.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for software testing, comprising:
receiving a set of test inputs for testing target software code; and
performing an iterative process that improves a quality measure of testing the target software code by the test inputs, a given iteration of the iterative process comprising:
applying one or more Artificial Intelligence (AI) models to the test inputs to: (i) generate one or more mutators, each mutator comprising executable code that produces one or more suggested mutations to the set of test inputs, and (ii) test the target software code using the suggested mutations so as to identify one or more selected mutations that improve the quality measure; and
adding the selected mutations to the set of test inputs.

2. The method according to claim 1, wherein the iterative process improves the quality measure by increasing a coverage of the target software code by the test inputs.

3. The method according to claim 1, wherein the iterative process improves the quality measure by triggering one or more bugs in the target software code.

4. The method according to claim 1, wherein generating the one or more mutators comprises (i) identifying a portion of the target software code that is not reached by the set of test inputs, and (ii) generating at least one mutator that produces at least one suggested mutation expected to reach the identified portion.

5. The method according to claim 1, wherein generating the one or more mutators comprises selecting, from the target software code, a software function to be researched next, and generating a mutator that produces a suggested mutation expected to improve the coverage of the selected software function.

6. The method according to claim 5, wherein selecting the software function comprises applying a selection criterion that considers, for a candidate function, a current coverage of the candidate function.

7. The method according to claim 5, wherein selecting the software function comprises applying a selection criterion that considers a threat model defined for the target software code.

8. The method according to claim 5, wherein selecting the software function comprises applying a selection criterion that considers, for a candidate function, a location of the candidate function relative to an entry point to a flow tree model representing the target software code.

9. The method according to claim 1, further comprising coalescing two or more of the mutators.

10. The method according to claim 1, further comprising discarding a mutator that produces a suggested mutation that is similar to a previous suggested mutation, in accordance with a defined similarity criterion.

11. The method according to claim 1, wherein generating the one or more mutators comprises providing the one or more AI models with a state of the target software code from an active software debugger.

12. The method according to claim 11, wherein the state of the target software code, provided from the active software debugger to the one or more AI models, pertains to a line of the target software code that blocks the set of test inputs from reaching a portion of the target software code.

13. The method according to claim 11, further comprising enabling the one or more AI models to execute the target software code incrementally so as to modify the state, and to access the modified state of the target software code.

14. A system for software testing, comprising:
a memory, to store target software code; and
one or more processors, to:
receive a set of test inputs for testing the target software code; and
perform an iterative process that improves a quality measure of testing the target software code by the test inputs, a given iteration of the iterative process comprising:
applying one or more Artificial Intelligence (AI) models to the test inputs to: (i) generate one or more mutators, each mutator comprising executable code that produces one or more suggested mutations to the set of test inputs, and (ii) test the target software code using the suggested mutations so as to identify one or more selected mutations that improve the quality measure; and
adding the selected mutations to the set of test inputs.

15. The system according to claim 14, wherein the iterative process improves the quality measure by increasing a coverage of the target software code by the test inputs.

16. The system according to claim 14, wherein the iterative process improves the quality measure by triggering one or more bugs in the target software code.

17. The system according to claim 14, wherein, in generating the one or more mutators, the one or more processors are to (i) identify a portion of the target software code that is not reached by the set of test inputs, and (ii) generate at least one mutator that produces at least one suggested mutation expected to reach the identified portion.

18. The system according to claim 14, wherein, in generating the one or more mutators, the one or more processors are to select, from the target software code, a software function to be researched next, and generate a mutator that produces a suggested mutation expected to improve the coverage of the selected software function.

19. The system according to claim 18, wherein the one or more processors are to select the software function by applying a selection criterion that considers, for a candidate function, a current coverage of the candidate function.

20. The system according to claim 14, wherein the one or more processors are to coalesce two or more of the mutators.

21. The system according to claim 14, wherein the one or more processors are to discard a mutator that produces a suggested mutation that is similar to a previous suggested mutation, in accordance with a defined similarity criterion.
